(19) United States
(12) Patent Application Publication
(10) Pub. No.: US 2018/0237622 A1
(43) Pub. Date: Aug. 23, 2018

(54) Polyolefin Blends Comprising Single-Site Catalyst Produced Syndiotactic Polypropylene and Polyethylene, Process and Articles Made From These Blends

(71) Applicant: Total Research & Technology Feluy, Seneffe (BE)

(72) Inventors: Claire Bouvy, Braine-le-Comte (BE); Olivier Lhost, Havre (BE); Jacques Michel, Feluy (BE)

(21) Appl. No.: 15/754,831

(22) PCT Filed: Aug. 31, 2016
(86) PCT No.: PCT/EP16/70526

§ 371 Date: Feb. 23, 2018

(30) Foreign Application Priority Data
Aug. 31, 2015 (EP) 15183184.9

(51) Int. Cl. C08L 23/12; C08K 7/14; C08L 23/06; C08K 3/04

(52) U.S. Cl. CPC C08L 23/12; C08K 7/14; C08L 23/06; C08L 2203/30; C08L 2314/06; C08L 2207/12; C08L 2308/00; C08K 3/041

(57) ABSTRACT

The invention relates to blends of at least one single-site catalyst polyethylene and at least one single-site catalyst syndiotactic polypropylene with a specific syndiotactic polypropylene content φ_{PP} in weight percent relative to the total weight of both the polyethylene and the syndiotactic polypropylene contained in the blend corresponding to:

$${ϕ}_{PP} = α \frac{100 MI {2}_{PE}}{{MFI}_{PP} + MI {2}_{PE}} \qquad ( I )$$

with α being at most 1.40, MI2_{PE} being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg. The blends show improved impact properties at temperatures below 0° C. The invention is also directed to a process for producing said blends, as well as to articles produced from these blends.

### FIELD OF THE INVENTION

The present invention relates to syndiotactic polypropylenes blended with polyethylenes. The invention also relates to articles produced from these blends as well as processes for producing these blends.

### BACKGROUND OF THE INVENTION

Syndiotactic polypropylenes are known to provide an interesting balance of flexural modulus, melting temperature and processability for many applications. However, polypropylene articles easily break at low temperature, especially below 0° C. Many applications that could take advantage of said interesting balance also require improved impact properties at sub-ambient temperatures, such as automobile parts.

Polypropylenes properties can be improved at low temperature with the introduction of a softer phase. For example impact polypropylene corresponds to a mixture of a matrix of polypropylene with a dispersed Ethylene-Propylene Rubber (EPR) phase. Thanks to this additional phase, the low temperature impact properties are significantly improved with a reduced decrease of the flexural modulus. However, EPR content in impact polypropylene is often limited in order to maintain the production cost in a reasonable area. As a consequence, the low temperature impact properties improvement is limited in a similar way. When further improvement of the low temperature impact properties is targeted, blends of polypropylene (or impact polypropylene) with a soft polymer such as polyethylene or Ethylene-Propylene-Diene-Monomer rubber (EPDM) rubber, or blend of polymers may be considered.

US2005/0027077 discloses the blend of an ethylene-propylene random copolymer with a modifier selected from the group consisting of metallocene-catalyzed polyethylene-based copolymer, metallocene-catalyzed polyethylene based terpolymer, and syndiotactic polypropylene homopolymer. The blends disclosed are used for film production, and the properties below 0° C. are not discussed.

In EP1495861 blends of polypropylene and metallocene polyethylene are reported to be an interesting option to produce high performance containers, wherein the impact resistance properties at low temperature may be improved by the presence of polyethylene in the blend. However, no properties below 0° C. have been reported in the examples. The document is silent about ductility properties.

US2004/0034167 discloses sPP blends with ultralow density metallocene polyethylene. The blends described in the examples show better Gardner drop impact properties at −25° C. than the sPP alone. EOD93-06 used in the examples has a MFIₚₚ of 4 g/10 min as measured according to ISO 1133 at 230° C. under a load of 2.16 kg. However, this document provides no teaching regarding the mechanism of failure or cause of a fracture in an end use application. No ductility properties are disclosed.

WO00/11078 discloses a blend of polyethylene and Ziegler-Natta polypropylene grade. Final blends are characterized by a good balance of tensile toughness, elongation and modulus at −10° C. However there is still a need for further improvement of the impact properties and/or the ductility of the compositions at low temperatures.

Thus it is an object of the invention to provide a syndiotactic polypropylene containing material with an improved balance of rigidity and impact properties, including impact resistance below 0° C.

It is also an object of the invention to provide a syndiotactic polypropylene containing material with an improved balance of rigidity, processability and impact properties, including impact resistance below 0° C.

It is a further object of the invention to provide a syndiotactic polypropylene containing material with an improved balance of rigidity, processability and impact properties, including ductility and impact resistance below 0° C.

### SUMMARY OF THE INVENTION

According to a first aspect, the invention provides a blend of at least one single-site catalyst polyethylene and at least one single-site catalyst syndiotactic polypropylene with a syndiotactic polypropylene content φ_{PP} in weight percent relative to the total weight of both the polyethylene and the syndiotactic polypropylene contained in the blend corresponding to:

$${ϕ}_{PP} = α \frac{100 MI {2}_{PE}}{{MFI}_{PP} + MI {2}_{PE}} \qquad ( I )$$

with α being at most 1.40, MI2_{PE} being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg.

The single-site catalysts used in the invention are preferably metallocene catalysts.

Surprisingly it has been found that such blends of single-site catalyst syndiotactic polypropylene and single-site catalyst polyethylene in specific blend proportions have an improved impact resistance below 0° C. while maintaining or slightly improving other targeted properties. The inventive blends also provide improvement in ductility especially when the failure mechanism is considered. The inventive blends provide therefore an improved balance in rigidity, impact properties, including ductility and impact resistance below 0° C. and processability.

With preference, one or more of the following features can be used to further define the inventive blend:
α is at most 1.30, and/or at least 0.50, preferably at least 0.70, more preferably at least 0.80, and even more preferably at least 0.90.
Said at least one single-site catalyst syndiotactic polypropylene has a syndiotactic index ranging from 70% to 90% as determined by ¹³C-NMR analysis.
The content of syndiotactic polypropylene is at most 75 wt %, preferably at most 65 w % relative to the total weight of both the polyethylene and the syndiotactic polypropylene contained in the blend.
The content of the syndiotactic polypropylene is at least 25 wt %, preferably at least 30 wt %, preferably at least 40 wt % relative to the total weight of both polyethylene and syndiotactic polypropylene contained in the blend.
The syndiotactic polypropylene has a melt flow index (MFI_{PP}) ranging from 0.1 to 1000 g/10 min, preferably 0.1 to 500 g/10 min. Preferably, the syndiotactic polypropylene has a melt flow index (MFI_{PP}) of at most 100 g/10 min.
The syndiotactic polypropylene is a homopolymer, a random copolymer of propylene and at least one comonomer or a mixture thereof.
The syndiotactic polypropylene has a melting temperature of at most 155° C., preferably of at most 153° C., more preferably of at most 150° C. and most preferably of at most 145° C. as determined according to ISO 3146.
The polyethylene and/or the syndiotactic polypropylene has a bimodal molecular weight distribution.
Both the polyethylene and the syndiotactic polypropylene have a molecular weight distribution Mw/Mn of at most 5, preferably at most 4.
Both the polyethylene and the syndiotactic polypropylene have a molecular weight distribution Mw/Mn of at least 2.0, preferably of at least 2.1.
The polyethylene has a MI2 of at least 0.5 g/10 min, more preferably of at least 1 g/10 min, even more preferably of at least 1.2 g/10 min and most preferably of at least 1.5 g/10 min as measured according to ISO 1133 at 190° C. under a load of 2.16 kg.
The polyethylene has a density of at least 0.850 g/cm³, more preferably of at least 0.900 g/cm³, even more preferably of at least 0.910 g/cm³ and most preferably of at least 0.915 g/cm³ as determined according to ISO 1183 at a temperature of 23° C.
At least one single-site catalyst catalyzed polyethylene is a metallocene polyethylene and/or at least one single-site catalyst catalyzed syndiotactic polypropylene is a metallocene syndiotactic polypropylene.
The blend further comprises from 0.1 wt % to 50 wt % of a filler, preferably the filler comprises one or more reinforcement material selected from glass fibers and carbon nanotubes.
The blend results of the blending of one metallocene syndiotactic polypropylene resin with one metallocene polyethylene resin.
The syndiotactic polypropylene and the polyethylene are in co-continuous phases in the blend.
The blend is devoid of compatibiliser, preferably selected from polypropylene grafted with maleic anhydride, polyethylene grafted with maleic anhydride, ethylene-vinyl acetate grafted with maleic anhydride, ethylene-octene copolymer (POE), ethylene-propylene rubber (EPR), ethylene-propylene diene rubber (EPDM) styrene-ethylene/butylene-styrene (SEBS) or any mixture thereof.
The at least one single-site catalyst catalyzed syndiotactic polypropylene in the blend is a syndiotactic polypropylene-based composition comprising at least one single-site catalyst catalyzed syndiotactic polypropylene and from 0.1 to 30 wt % of an isotactic polypropylene as based on the total weight of the syndiotactic polypropylene-based composition.
The blend has a ductility index determined at −20° C. of at least 35%, preferably at least 40%, the ductility index being calculated to the following equation (II):

$$Ductility index ( \% ) = \frac{E ( break ) - E ( peak )}{E ( break )} \times 100 \qquad ( II )$$

wherein E(break) is the falling weight average energy at break as determined at −20° C. and E(peak) is the falling weight average energy at peak as determined at −20° C.

According to a second aspect, the invention encompasses the use of the inventive blends to produce articles, and the articles produced from the inventive blends. In an embodiment the articles are thermoformed articles or molded articles selected from injection molded articles, compression molded articles, rotomoulded articles, injection blow molded articles, and injection stretch blow molded articles, preferably injection molded articles. In an embodiment, the articles are selected from the group consisting of automobile parts, food or non-food packaging, retort packaging, housewares, caps, closures, media packaging, medical devices and pharmacopoeia packages. Preferably they are automobile parts. In an embodiment, the articles are not films and/or not fibers and/or not membranes.

According to a third aspect, the invention relates to a process for production of a polyolefin blend comprising the steps of:
providing at least one syndiotactic polypropylene produced in the presence of a single-site catalyst (preferably metallocene catalyst) catalyzed in one or more reactors;
providing at least one polyethylene produced in the presence of a single-site catalyst (preferably metallocene catalyst) catalyzed in one or more reactors;
blending said at least one syndiotactic polypropylene together with said at least one polyethylene to produce a blend, wherein the syndiotactic polypropylene content φ_{PP} in weight percent relative to the total weight of both the polyethylene and the syndiotactic polypropylene contained in the blend is:

$${ϕ}_{PP} = α \frac{100 MI {2}_{PE}}{{MFI}_{PP} + MI {2}_{PE}}$$

with α being at most 1.40, MI2_{PE} being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg.

With preference, one or more of the following features can be used to further define the inventive process:
The polyolefin blend produced according to the third aspect of the invention is the blend described in relation to the first aspect of the invention.
The blending of said at least one said syndiotactic polypropylene together with said at least one said polyethylene is a physical blending.
Said at least one syndiotactic polypropylene and/or said at least one polyethylene are produced in a loop reactor.
The process has no step of blending a compatiliser selected from polypropylene grafted with maleic anhydride, polyethylene grafted with maleic anhydride, ethylene-vinyl acetate grafted with maleic anhydride, ethylene-octene copolymer (POE), ethylene-propylene rubber (EPR), ethylene-propylene diene rubber (EPDM) styrene-ethylene/butylene-styrene (SEBS) or any mixture thereof, together with said at least one syndiotactic polypropylene and/or said at least one polyethylene.

### DESCRIPTION OF THE FIGURES

FIG. 1 is a scanning electron picture showing the morphology of an injected sample of the inventive blend.

### DETAILED DESCRIPTION OF THE INVENTION

For the purpose of the invention, the terms “syndiotactic polypropylene” (sPP) and “syndiotactic propylene polymer” may be used synonymously. The term “single-site catalyst syndiotactic polypropylene” is used to denote a polypropylene produced with a single-site-based polymerisation catalyst. Amongst single-site catalysts, metallocene catalysts are preferred. In such case, the produced “metallocene syndiotactic polypropylene” will be labeled as “msPP” but, as all industrial syndiotactic polypropylene grades are produced from metallocene catalysts, “msPP” is often simplified as “sPP”.

In a similar way, the terms “polyethylene” (PE) and “ethylene polymer” may be used synonymously. The term “single-site catalyst polyethylene” is used to denote a polyethylene produced with a single-site-based polymerisation catalyst. Amongst single-site catalysts, metallocene catalysts are preferred. In such case, the produced “metallocene polyethylene” will be labeled as “mPE”.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all numbers and fractions subsumed within the respective ranges, as well as the recited endpoints.

The particular features, structures, characteristics or embodiments may be combined in any suitable manner, as would be apparent to a person skilled in the art from this disclosure, in one or more embodiments.

The terms “syndiotactic polypropylene”, “syndiotactic polypropylene resin”, “polyethylene” or “polyethylene resin” as used herein refer respectively to the polypropylene fluff or powder, or the polyethylene fluff or powder, that is extruded, and/or melted and/or pelletized and can be produced through compounding and homogenizing of the syndiotactic polypropylene resins or polyethylene resins as taught herein, for instance, with mixing and/or extruder equipment. The terms “fluff” or “powder” as used herein refer to the syndiotactic polypropylene material or to the polyethylene material with the hard catalyst particle at the core of each grain and is defined as the polymer material after it exits the polymerisation reactor (or final polymerisation reactor in the case of multiple reactors connected in series).

The invention provides a blend of at least one single-site catalyst polyethylene and at least one single-site catalyst syndiotactic polypropylene with a syndiotactic polypropylene content φ_{PP} in weight percent relative to the total weight of both the polyethylene and the syndiotactic polypropylene contained in the blend corresponding to:

$${ϕ}_{PP} = α \frac{100 MI {2}_{PE}}{{MFI}_{PP} + MI {2}_{PE}} \qquad ( I )$$

with α being at most 1.40, MI2_{PE} being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg.

If α is higher than 1.40, the blend may not show the targeted improvement in ductility and in the impact properties at −20° C. In an embodiment α is at most 1.30.

A minimal value of a may be considered for a further improvement of the impact properties at 23° C. Thus, in an embodiment α is at least 0.50, preferably at least 0.70, more preferably at least 0.80, and even more preferably at least 0.90.

The specific blend proportions of the single-site catalyst syndiotactic polypropylene and single-site catalyst polyethylene provide an unexpected improvement of the impact properties at low temperatures while maintaining or slightly improving other targeted properties.

Syndiotactic Polypropylene

Syndiotactic polypropylene is polypropylene wherein the methyl groups attached to the tertiary carbon atoms of the successive monomeric unit are arranged as racemic dyads. In other words, the methyl groups syndiotactic polypropylene lie on alternate sides of the polymer backbone. Syndiotactity may be measured by ¹³C-NMR analysis as described in the test methods and may be expressed as the percentage of syndio pentads (% rrrr). As used herein, the term “syndio pentads” refers to successive methyl groups located on alternate sides of the polymer chain. Preferably the content of rrrr pentads is ranging from 70 to 90 mol % as determined by ¹³C-NMR analysis.

The syndiotactic polypropylene contemplated in the inventive blend is produced by single-site catalyst, preferably metallocene catalyst.

Preferably, the syndiotactic polypropylene is characterized by a percentage of 2,1-insertions, relative to the total number of propylene molecules in the polymer chain, of at least 0.1 mol %, preferably at least 0.2 mol %.

Preferably, the syndiotactic polypropylene is further characterized by a percentage of 2,1-insertions, relative to the total number of propylene molecules in the polymer chain, of at most 1.5 mol %, more preferably of at most 1.3 mol %. The percentage of 2,1-insertions may be determined as indicated in the test methods.

The syndiotactic polypropylene has a melt flow index (MFI_{PP}) ranging from 0.1 to 1000 g/10 min, preferably 0.1 to 500 g/10 min. Preferably, the syndiotactic polypropylene has a melt flow index (MFI_{PP}) of at most 100 g/10 min. The value of WI of the polypropylene is obtained without degradation treatment.

Preferably, the syndiotactic polypropylene has a molecular weight distribution (MWD), defined as Mw/Mn, i.e. the ratio of weight average molecular weight (Mw) over number average molecular weight (Mn), of at most 10, preferably of at most 5, more preferably of at most 4.

Preferably, the syndiotactic polypropylene has a molecular weight distribution (MWD), defined as Mw/Mn, i.e. the ratio of weight average molecular weight (Mw) over number average molecular weight (Mn), of at least 2.0, preferably of at least 2.1.

The molecular weight distribution (MWD) of the syndiotactic propylene polymer may be monomodal or multimodal, for example bimodal. A multimodal molecular weight distribution is obtained by combining at least two syndiotactic propylene polymers having different melt flow indices. The syndiotactic polypropylene may be monomodal or multimodal. In an embodiment of the invention, the syndiotactic propylene polymer has a multimodal molecular weight distribution, preferably a bimodal molecular weight distribution.

The syndiotactic polypropylene has a density at room temperature ranging from 0.850 g/cm³ to 0.950 g/cm³. Preferably the syndiotactic polypropylene has a density at room temperature ranging from 0.870 g/cm³ to 0.920 g/cm³ as determined according to ISO 1183 at a temperature of 23° C.

Preferably, the syndiotactic polypropylene has a melting temperature of at most 155° C., preferably of at most 153° C., more preferably of at most 150° C. and most preferably of at most 145° C. The melting temperature is determined according to ISO 3146.

A method for producing a syndiotactic polypropylene using a metallocene catalyst, and such a metallocene syndiotactic polypropylene, is disclosed in EP2076550 which is enclosed by reference in its entirety.

Syndiotactity may be measured by ¹³C-NMR analysis as described in the test methods and may be expressed as a syndiotactic index. Preferably the syndiotactic index is ranging from 70 to 90% as determined by ¹³C-NMR analysis.

The syndiotactic polypropylene is a homopolymer, a copolymer of propylene and at least one comonomer, or a mixture thereof. Suitable comonomers can be selected from the group consisting of ethylene and aliphatic C₄-C₂₀ alpha-olefins. Examples of suitable aliphatic C₄-C₂₀ alpha-olefins include 1-butene, 1-pentene, 4-methyl-1-pentene, 1-hexene, 1-octene, 1-decene, 1-dodecene, 1-tetradecene, 1-hexadecene, 1-octadecene and 1-eicosene. Preferably, the comonomer is ethylene or 1-hexene. More preferably the comonomer is ethylene.

In a preferred embodiment of the invention, the syndiotactic polypropylene is a homopolymer of propylene. A homopolymer according to this invention has less than 0.1 wt %, preferably less than 0.05 wt % and more preferably less than 0.005 wt %, of alpha-olefins other than propylene in the polymer. Most preferred, no other alpha-olefins are detectable.

In an embodiment, the syndiotactic propylene polymer is a syndiotactic propylene copolymer. The syndiotactic propylene copolymer can be a random copolymer, a heterophasic copolymer, or a mixture thereof.

The random syndiotactic propylene copolymer comprises at least 0.1 wt % of one or more comonomers, preferably at least 1 wt %. The random syndiotactic propylene copolymer comprises up to 10 wt % of one or more comonomers and most preferably up to 6 wt %. Preferably, the random copolymer is a copolymer of syndiotactic propylene and ethylene.

The heterophasic copolymer of syndiotactic propylene comprises a dispersed phase, generally constituted by an elastomeric ethylene-propylene copolymer (for example EPR), distributed inside a semi-crystalline syndiotactic polypropylene matrix being a homopolymer of syndiotactic propylene or a random syndiotactic propylene copolymer.

With preference, the syndiotactic polypropylene is a homopolymer, a random copolymer of syndiotactic propylene and at least one comonomer or a mixture thereof.

Preferably, the syndiotactic polypropylene is not and/or does not comprise a terpolymer.

The invention also encompasses syndiotactic polypropylene compositions comprising the syndiotactic polypropylene as defined above.

Preferably, the polymerisation of syndiotactic propylene and one or more optional comonomers is performed in the presence of one or more metallocene-based catalytic systems comprising one or more metallocene components, a support and an activating agent.

Polyethylene

The polyethylene contemplated in the invention is made using single-site catalysts, preferably metallocene catalysts.

The polyethylene has a melt flow index (MI2) as from 0.001 to 1000 g/10 min. Preferably, the polyethylene has a melt flow index (MI2) of at most 500 g/10 min, preferably at most 100 g/10 min. Preferably, the polyethylene has a MI2 of at least 0.5 g/10 min, more preferably of at least 1 g/10 min, even more preferably of at least 1.2 g/10 min and most preferably of at least 1.5 g/10 min.

Preferably, the polyethylene has a molecular weight distribution (MWD), defined as Mw/Mn, i.e. the ratio of weight average molecular weight (Mw) over number average molecular weight (Mn) of at most 10, preferably of at most 5, more preferably of at most 4.

Preferably, the polyethylene has a molecular weight distribution (MWD), defined as Mw/Mn, i.e. the ratio of weight average molecular weight (Mw) over number average molecular weight (Mn) of at least 2.0, preferably of at least 2.1.

In an embodiment, the polyethylene has a monomodal molecular weight distribution. In another embodiment, the polyethylene has a multimodal molecular weight distribution, preferably a bimodal molecular weight distribution. The polyethylene may be monomodal or multimodal.

The density at room temperature of the polyethylene is ranging from 0.820 g/cm³ to 0.980 g/cm³. Preferably, the polyethylene has a density of at most 0.960 g/cm³. Preferably, the polyethylene has a density of at least 0.850 g/cm³, more preferably of at least 0.900 g/cm³, even more preferably of at least 0.910 g/cm³ and most preferably of at least 0.915 g/cm³. The density is determined according to ISO 1183 at a temperature of 23° C.

The polyethylene is selected from low density polyethylene (LDPE), medium density polyethylene (MDPE), high density polyethylene (HDPE), and mixtures thereof.

The polyethylene is a homopolymer, a copolymer of ethylene and at least one comonomer, or a mixture thereof. Suitable comonomers comprise but are not limited to aliphatic C₃-C₂₀ alpha-olefins. Examples of suitable aliphatic C₃-C₂₀ alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene.

The term “copolymer” refers to a polymer which is made by linking ethylene and at least one comonomer in the same polymer chain. The term homopolymer refers to a polymer which is made in the absence of comonomer or with less than 0.1 wt %, more preferably less than 0.05 wt %, most preferably less than 0.005 wt % of comonomer.

In case the polyethylene is a copolymer, it comprises at least 0.1 wt % of comonomer, preferably at least 1 wt %. The ethylene copolymer comprises up to 10 wt % of comonomer and most preferably up to 6 wt %. In an embodiment of the invention the comonomer is 1-hexene.

The invention also encompasses polyethylene compositions comprising the polyethylene as defined above.

The polymerisation of ethylene and one or more optional comonomers is performed in the presence of one or more metallocene-based catalytic systems comprising one or more metallocene component, a support and an activating agent.

Production Metallocene-Based Catalytic Systems

The syndiotactic polypropylene and/or the polyethylene resins are preferably prepared in a reactor, either in gas phase, in bulk (for syndiotactic polypropylene), in solution or in slurry conditions. Preferably, said syndiotactic polypropylene is prepared under bulk conditions and said polyethylene is prepared under slurry conditions. More preferably said syndiotactic polypropylene and/or polyethylene are produced in a loop reactor that preferably comprises interconnected pipes defining a reactor path and wherein liquid propylene is injected for syndiotactic polypropylene, or a slurry is preferably pumped through said loop reactor for polyethylene. Preferably, the syndiotactic polypropylene and/or polyethylene resin is each produced in a double loop reactor, comprising two loop reactors connected in series. Preferably, each of the syndiotactic polypropylene and the polyethylene resin is produced separately in a single or a double loop reactor.

As used herein the term “polymerisation slurry” or “polymer slurry” or “slurry” means substantially a multi-phase composition including at least polymer solids and a liquid phase, the liquid being the continuous phase. The solids include catalyst and a polymerised olefin, such as syndiotactic polypropylene or polyethylene. The liquid include an inert diluent such as isobutane, dissolved monomer(s) such as propylene or ethylene, optional comonomer(s), molecular weight control agents such as hydrogen, antistatic agents, antifouling agents, scavengers and other process additives.

The single-site catalyst-based catalytic systems are known to the person skilled in the art. Amongst these catalysts, metallocene are preferred. The metallocene catalysts are compounds of Group IV transition metals of the Periodic Table such as titanium, zirconium, hafnium, etc., and have a coordinated structure with a metal compound and a ligand composed of one or two groups of cyclopentadienyl, indeny, fluorenyl or their derivatives. The use of metallocene catalysts in the polymerisation of olefins has various advantages. Metallocene catalysts have high activities and are capable of preparing polymers with enhanced physical properties. Metallocenes comprise a single metal site, which allows for more control of branching and molecular weight distribution of the polymer.

The metallocene component used to prepare the polyethylenes can be any bridged metallocene known in the art. Supporting method and polymerisation processes are described in many patents, for example in WO2012/001160A2 which is enclosed by reference in its entirety. Preferably it is a metallocene represented by the following general formula:

μ-R¹(C₅R²R³R⁴R⁵)(C₅R⁶R⁷R⁸R⁶)MX¹X² (III)

wherein
the bridge R¹ is —(CR¹⁰R¹¹)ₚ— or —(SiR₁₀R¹¹)ₚ— with p=1 or 2, preferably it is —(SiR¹⁰R¹¹)—;
M is a metal selected from Ti, Zr and Hf, preferably it is Zr;
X¹ and X² are independently selected from the group consisting of halogen, hydrogen, C₁-C₁₀ alkyl, C₆-C₁₅ aryl, alkylaryl with C₁-C₁₀ alkyl and C₆-C₁₅ aryl;
R², R³, R⁴, R⁵, R⁶, R⁷, R⁸, R⁹, R¹⁰ and R¹¹ are each independently selected from the group consisting of hydrogen, C₁-C₁₀ alkyl, C₅-C₇ cycloalkyl, C₆-C₁₅ aryl, alkylaryl with C₁-C₁₀ alkyl and C₆-C₁₅ aryl, or any two neighboring R may form a cyclic saturated or non-saturated C₄-C₁₀ ring; each R², R³, R⁴, R⁵, R⁶, R⁷, R⁸, R⁹, R¹⁰ and R¹¹ may in turn be substituted in the same way.

The preferred metallocene components are represented by the general formula (III), wherein
the bridge R¹ is SiR¹⁰R¹¹;
M is Zr;
X¹ and X² are independently selected from the group consisting of halogen, hydrogen, and C₁-C₁₀ alkyl; and
(C₅R²R³R⁴R⁵) and (C₅R⁶R⁷R⁸R⁹) are indenyl of the general formula C₉R¹²R¹³R¹⁴R¹⁵R¹⁶R¹⁷R¹⁸R¹⁹, wherein R¹², R¹³, R¹⁴, R¹⁵, R¹⁶, R¹⁷, and R¹⁸ are each independently selected from the group consisting of hydrogen, C₁-C₁₀ alkyl, C₅-C₇ cycloalkyl, C₆-C₁₅ aryl, and alkylaryl with C₁-C₁₀ alkyl and C₆-C₁₅ aryl, or any two neighboring R may form a cyclic saturated or non-saturated C₄-C₁₀ ring;
R¹⁰ and R¹¹ are each independently selected from the group consisting of C₁-C₁₀ alkyl, C₅-C₇ cycloalkyl, and C₆-C₁₅ aryl, or R¹⁰ and R¹¹ may form a cyclic saturated or non-saturated C₄-C₁₀ ring; and
each R¹⁰, R¹¹, R¹², R¹³ R¹⁴ R¹⁵ R¹⁶ R¹⁷ and R¹⁸ may in turn be substituted in the same way.

Particularly suitable metallocenes are those having C₂-symmetry or several characterized by a C1 symmetry.

Examples of particularly suitable metallocenes are:
dimethylsilanediyl-bis(cyclopentadienyl)zirconium dichloride,
dimethylsilanediyl-bis(2-methyl-cyclopentadienyl)zirconium dichloride,
dimethylsilanediyl-bis(3-methyl-cyclopentadienyl)zirconium dichloride,
dimethylsilanediyl-bis(3-tert-butyl-cyclopentadienyl)zirconium dichloride,
dimethylsilanediyl-bis(3-tert-butyl-5-methyl-cyclopentadienyl)zirconium dichloride,
dimethylsilanediyl-bis(2,4-dimethyl-cyclopentadienyl)zirconium dichloride,
dimethylsilanediyl-bis(indenyl)zirconium dichloride,
dimethylsilanediyl-bis(2-methyl-indenyl)zirconium dichloride,
dimethylsilanediyl-bis(3-methyl-indenyl)zirconium dichloride,
dimethylsilanediyl-bis(3-tert-butyl-indenyl)zirconium dichloride,
dimethylsilanediyl-bis(4,7-dimethyl-indenyl)zirconium dichloride,
dimethylsilanediyl-bis(tetrahydroindenyl)zirconium dichloride,
dimethylsilanediyl-bis(benzindenyl)zirconium dichloride,
dimethylsilanediyl-bis(3,3′-2-methyl-benzindenyl)zirconium dichloride,
dimethylsilanediyl-bis(4-phenyl-indenyl)zirconium dichloride,
ethylene-bis(indenyl)zirconium dichloride,
ethylene-bis(tetrahydroindenyl)zirconium dichloride,
isopropylidene-(3-tert-butyl-5-methyl-cyclopentadienyl)(fluorenyl) zirconium dichloride.

The metallocene component used to prepare the metallocene syndiotactic polypropylenes is described in many patents such as for example U.S. Pat. No. 6,184,326 B1 which is include by reference in its entirety. Supporting techniques are similar to those described in WO2012/001160A2.

The metallocene may be supported according to any method known in the art. In the event it is supported, the support used in the present invention can be any organic or inorganic solid, particularly a porous support such as silica, talc, inorganic oxides, and resinous support material such as polyolefin. Preferably, the support material is an inorganic oxide in its finely divided form.

The polymerisation of propylene and one or more optional comonomers in the presence of a metallocene-based catalytic system can be carried out according to known techniques in one or more polymerisation reactors. The metallocene syndiotactic polypropylene is preferably produced by polymerisation in liquid propylene at temperatures in the range from 20° C. to 100° C. Preferably, temperatures are in the range from 60° C. to 80° C. The pressure can be atmospheric or higher. It is preferably between 25 and 50 bar. The molecular weight of the polymer chains, and in consequence the melt flow of the metallocene syndiotactic polypropylene, is mainly regulated by the addition of hydrogen to the polymerisation medium.

Preferably, the metallocene syndiotactic polypropylene is recovered from the one or more polymerisation reactors without post-polymerisation treatment to reduce its molecular weight and/or narrow its molecular weight distribution, such as can be done by thermal or chemical degradation. An example for chemical degradation is visbreaking, wherein the syndiotactic polypropylene is reacted for example with an organic peroxide at elevated temperatures, for example in an extruder or pelletising equipment.

The polymerisation of ethylene and one or more optional comonomers in the presence of a metallocene-based catalyst system can be carried out according to known techniques in one or more polymerisation reactors. The metallocene polyethylene of the present invention is preferably produced by polymerisation in an “isobutane-ethylene-supported catalyst” slurry at temperatures in the range from 20° C. to 110° C., preferably in the range from 60° C. to 110° C. The pressure can be atmospheric or higher. It is preferably between 25 and 50 bar. The molecular weight of the polymer chains, and in consequence the melt flow of the metallocene polyethylene, is mainly regulated by the addition of hydrogen in the polymerisation medium. The density of the polymer chains is regulated by the addition of one or more comonomers in the polymerisation medium.

Blends

The present invention relates to the blending, preferably the physical blending, of at least two different polyolefin resins produced with single-site catalysts, preferably metallocene catalysts. Both resins are produced separately, preferably in separate reactors.

Surprisingly, the present invention found that single-site catalyst syndiotactic polypropylenes and single-site catalyst polyethylenes can be blended in specific proportions to form compositions/blends having an improved impact resistance at low temperature without requiring the addition of any compatibiliser.

The invention provides blends wherein the syndiotactic polypropylene content is determined by a relationship between the viscosity of the blended syndiotactic polypropylene and polyethylene, said relationship being expressed by the value a. The syndiotactic polypropylene weight content is defined in relation to the total weight of both the polyethylene and the syndiotactic polypropylene contained in the blend.

The invention provides blends of at least one single-site catalyst polyethylene and at least one single-site catalyst syndiotactic polypropylene with a syndiotactic polypropylene content S_{PP} in weight percent relative to the total weight of both the polyethylene and the syndiotactic polypropylene contained in the blend corresponding to:

$${ϕ}_{PP} = α \frac{100 MI {2}_{PE}}{{MFI}_{PP} + MI {2}_{PE}} \qquad$$

with α being at most 1.40, MI2_{PE} being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg.

If α is higher than 1.40, the blend may not show the targeted improvement in ductility and in the impact properties at −20° C. In an embodiment α is at most 1.30.

Surprisingly such blends show an improved falling weight properties at −20° C. compared to blends with polyethylene produced with a catalyst that is not a single-site catalyst. Another surprise is the failure mechanism. Indeed only ductile breaks at −20° C. are observed for the inventive blends, whereas comparative blends with polyethylene not produced with a single-site catalyst show a mixture of ductile and fragile breaks or only fragile breaks.

A minimal value of a may be considered for a further improvement of the impact properties at 23° C. Thus, in an embodiment α is at least 0.50, preferably at least 0.70, more preferably at least 0.80 and most preferably at least 0.90. For such values of a, only ductile breaks can be obtained with the inventive blends contrary to blends containing polymers not produced using single site catalysts.

In an embodiment, the blends of the present invention comprise at most 75 wt %, preferably at most 70 wt %, more preferably at most 65 wt %, even more preferably, at most 60 wt % and most preferably at most 55 wt % of syndiotactic polypropylene relative to the total weight of both polyethylene and syndiotactic polypropylene contained in the blend.

In an embodiment, the blends of the present invention comprise at least 25 wt %, preferably at least 35 wt %, preferably at least 30 wt %, more preferably at least 40 wt %, even more preferably at least 45 wt % and most preferably of at least 50 wt % of syndiotactic polypropylene relative to the total weight of both the polyethylene and the syndiotactic polypropylene contained in the blend.

Preferably, the inventive blends show a ductility index of at least 35%, preferably of at least 40%. The ductility index is determined at −20° C. and according to the following equation:

$$Ductility index ( \% ) = \frac{E ( break ) - E ( peak )}{E ( break )} \times 100 \qquad ( II )$$

wherein E(break) is the falling weight average energy at break (in Joule) and E(peak) is the falling weight average energy at peak (in Joule). This ductility index is calculated using the falling weight impact experimental results.

In an embodiment, the single-site catalyst syndiotactic polypropylene and single-site catalyst polyethylene are produced in a sequence of reactors, one or more reactors for the production of syndiotactic polypropylene and/or one or more reactors for the production of polyethylene. Preferably the single-site catalyst syndiotactic polypropylene resin and the single-site catalyst polyethylene resin are physically blended into a device for melting and blending said resins selected from a mixer, an extruder or combination thereof. For example, said device is an extruder and/or mixer. Preferably the device is an extruder. A preferred extruder is a co-rotating twin screw. A preferred mixer is a counter-rotating twin screw.

The blends according to the invention result of the blending of:
one single-site catalyst syndiotactic polypropylene resin with one single-site catalyst polyethylene resin; or
one single-site catalyst syndiotactic polypropylene resin with two or more single-site catalyst polyethylene resins of different melt index and/or of different density; or
two or more single-site catalyst syndiotactic polypropylene resins of different melt index and/or of different comonomer content with one single-site catalyst polyethylene resin; or
two or more single-site catalyst syndiotactic polypropylene resins of different melt index and/or comonomer content with two or more single-site catalyst polyethylene resins of different melt index and/or density.

When the blends contain two or more single-site catalyst syndiotactic polypropylene resins of different melt index, the MFI_{PP} to be considered is the MFI measured on the mixture of said two or more single-site catalyst syndiotactic polypropylene resins. Thus, in order to determine the syndiotactic polypropylene content φ_{PP} in the blend in accordance to the invention, the man skilled in the art can mix the two or more syndiotactic polypropylene resins in a first step and then determine the MFI_{PP} of the resulting mixture according to ISO 1133 at 230° C. under a load of 2.16 kg.

In a similar way, when the blends contain two or more single-site catalyst polyethylene resins of different melt index, the MI2_{PE} to be considered is the MI2 measured on the mixture of said two or more single-site catalyst polyethylene resins. Thus, in order to determine the syndiotactic polypropylene content φ_{PP} in the blend in accordance to the invention, the man skilled in the art can mix the two or more polyethylene resins in a first step and then determine the MI2_{pE} of the resulting mixture according to ISO 1133 at 190° C. under a load of 2.16 kg.

In an embodiment, the blends according to the invention also contain non-single-site catalyzed polymer such as non-single-site catalyzed syndiotactic polypropylene and/or non-single-site catalyzed polyethylene.

When non-single-site catalyzed syndiotactic polypropylene is present in the blend, for example Ziegler-Natta catalyzed syndiotactic polypropylene, the syndiotactic polypropylene content φ_{PP} in weight percent relative to the total weight of both the polyethylene and the syndiotactic polypropylene contained in the blend is the sum of the content of both single-site catalyzed syndiotactic polypropylene and non-single-site catalyzed syndiotactic polypropylene.

When non-single-site catalyzed syndiotactic polypropylene is present in the blend, its content in weight percent is at most 10 wt %, preferably at most 5 wt %, more preferably at most 2 wt % relative to the total weight of both the polyethylene and the syndiotactic polypropylene contained in the blend.

In a preferred embodiment, all the syndiotactic polypropylene contained in the blend is single-site catalyzed syndiotactic polypropylene. Thus the blend is devoid of syndiotactic polypropylene produced by a catalyst other than single-site catalysts; preferably the blend is devoid of syndiotactic polypropylene produced by a catalyst other than metallocene catalysts.

When non-single-site catalyzed polyethylene is present in the blend—for example Ziegler-Natta catalyzed polyethylene—its content in weight percent is at most 10 wt %, preferably at most 5 wt %, more preferably at most 2 wt % relative to the total weight of both the polyethylene and the syndiotactic polypropylene contained in the blend.

In a preferred embodiment, all the polyethylene contained in the blend is single-site catalyzed polyethylene. Thus the blend is devoid of polyethylene produced by a catalyst other than single-site catalysts; preferably the blend is devoid of polyethylene produced by a catalyst other than metallocene catalysts.

In an embodiment, the polyethylene and/or the syndiotactic polypropylene has a bimodal molecular weight distribution.

In an embodiment, both the polyethylene and the syndiotactic polypropylene have a molecular weight distribution Mw/Mn of at most 5, preferably of at most 4, and/or of at least 2.0, preferably of at least 2.1.

With preference, the blends according to the invention result of the blending of one metallocene syndiotactic polypropylene resin with one metallocene polyethylene resin.

In an embodiment, the at least one single-site catalyst catalyzed syndiotactic polypropylene in the blend is a syndiotactic polypropylene-based composition comprising at least one single-site catalyst catalyzed syndiotactic polypropylene and from 0.1 to 30 wt % of an isotactic polypropylene as based on the total weight of the syndiotactic polypropylene-based composition. The isotactic polypropylene can be single-site catalyzed or not. When it is metallocene-catalyzed, the metallocene components that can be used can be any bridged metallocene known in the art and described here before for the polymerization of polyethylenes.

The present invention encompasses steps for preparing the syndiotactic polypropylene resin and/or the polyethylene resin. The resins are preferably prepared, in one or more reactor, either in gas phase, in bulk or in slurry condition. Polyethylene is preferably produced in slurry or gas phase process and syndiotactic polypropylene is preferably produced in bulk process. For slurry and bulk processes, the reactors used can be single loop reactors or double loop reactors.

Without being bound by a theory, it is believed that the content of single-site catalyst syndiotactic polypropylene relative to the total weight of both the polyethylene and the syndiotactic polypropylene contained in the blend, allows obtaining, at least when a is close to 1 (preferably when a is at least 0.50), co-continuous blends. The absence of imposed stress transfer across an interface in a co-continuous morphology is presented in the literature as a way to obtain good mechanical properties. Co-continuous blends are known to improve the impact strength and the tensile strength of the resulting product compared to blends with dispersed morphology. However, the existence of a co-continuous morphology is not enough to explain the interesting mechanical properties measured in the inventive blends. Indeed, comparative blends with polyethylene not produced with a single-site catalyst may also show said co-continous morphology but not said improvements in low temperature mechanical properties. This will be demonstrated by the comparative examples in the below example section.

In an embodiment, the syndiotactic polypropylene and the polyethylene are in co-continuous phases in the inventive blends.

Advantageously, the blends of the invention are devoid of compatibiliser such as modified (functionalized) polymers (e.g. polypropylene grafted with maleic anhydride or polyethylene grafted with maleic anhydride), ethylene-vinyl acetate grafted with maleic acid, ethylene-octene copolymer (POE), ethylene-propylene rubber (EPR), ethylene-propylene diene rubber (EPDM) styrene-ethylene/butylene-styrene (SEBS), low molecular weight compound having reactive polar groups, or any mixture thereof.

Thus, in an embodiment, the process of the invention has no step of blending a compatiliser selected from polypropylene grafted with maleic anhydride, polyethylene grafted with maleic anhydride, ethylene-vinyl acetate grafted with maleic anhydride, ethylene-octene copolymer (POE), ethylene-propylene rubber (EPR), ethylene-propylene diene rubber (EPDM) styrene-ethylene/butylene-styrene (SEBS) or any mixture thereof, together with said at least one syndiotactic polypropylene and/or said at least one polyethylene.

However, in an embodiment, the syndiotactic polypropylene resin and/or the polyethylene resin and/or the inventive blend may also comprise additives, such as by way of example, antioxidants, light stabilizers, acid scavengers, lubricants, antistatic additives, nucleating agents and colorants. An overview of such additives may be found in Plastics Additives Handbook, ed. H. Zweifel, 5th edition, 2001, Hanser Publishers, Annex 3, pages 181-212.

Optionally, the blend further comprises from 0.1 wt % to 50 wt % relative to the total weight of the blend, of a filler.

Preferred filler is one or more selected from reinforcement material, pigments, metallic flakes, glass flakes, milled glass, glass sphere and mineral filler such as talc, wollastonite, calcium carbonate, mica, silicates, kaolin, barium sulfate, metal oxides and hydroxides.

Preferred reinforcement material comprises one or more fibers selected from organic or inorganic such as fibers made of glass, metal, ceramic, graphite, carbon nanotubes, bamboo and organic polymers such as polyesters and nylons, e.g. aramids, in filamentary form, all of which are commercially available. If a reinforcement material is added, the reinforcement material preferably comprises glass fibers or carbon nanotubes.

Preferred pigments include organic and inorganic substances and are one or more selected from carbon black, TiO₂, ZnO, chromium oxides, iron oxides, azo pigments, phthalocyanines, quinacridones, perylene pigments, naphthalene derivates, isoindo lines, anthraquinone pigments.

The blends of the present invention may be transformed into articles by a transformation method selected from the group comprising thermoforming, injection molding, compression molding, rotomoulding, injection blow molding and injection stretch blow molding. Preferably the method of transformation is injection molding. The articles of the present invention are selected from the group consisting of automobile parts, food or non-food packaging, retort packaging, housewares, caps, closures, media packaging, medical devices and pharmacopoeia packages. They can also contain one or more living hinges.

The blends according to the invention can be used for any article that is produced by injection molding. The injection molding process comprises the steps of:

(a) blending the single-site catalyst syndiotactic polypropylene and single-site catalyst polyethylene in defined proportions to produce a polyolefin blend according to the invention; (b) melting said polyolefin blend, and

(c) injecting the molten polyolefin blend from step (b) into an injection mold to form an injection-molded article.

In step (a), the blend is obtained via a polymerisation of the two polyolefins in a sequence of reactors, via a dry blend or via a preliminary pelletisation of the blend.

The injection molding is performed using methods and equipment well known to the person skilled in the art.

The present invention also relates to the use of the blends according to the present invention for manufacturing molded articles and in particular for the manufacturing of injection molded articles. The details and embodiments described above in connection with the inventive blends also apply to the use according to the present invention.

In particular, examples of articles produced from the inventive blends may be cups, tubs, pails, buckets, toys, household appliances, containers, caps, closures, and crates, to only name a few.

The inventive blends are particularly suited for automobile parts. Thus, said blends can be used to produce automobile parts such as interior parts like door panels; instrument panels; consoles; A, B and C pillar trims; seat protectors; air ducts; door lists; door trims; air-bag containers and others. The automobile parts also include exterior parts like body panels, bumpers, rocker panels, door lists, side sills, cowl covers and others.

With preference, the articles produced from the inventive blends are not films and/or not fibers and/or not membranes.

Test Methods

The melt flow index (MI2) of the polyethylene or polyethylene composition is determined according to ISO 1133 at 190° C. under a load of 2.16 kg.

The melt flow index (MFI_{PP}) of the syndiotactic polypropylene or syndiotactic polypropylene composition is determined according to ISO 1133 at 230° C. under a load of 2.16 kg.

Molecular weights are determined by Size Exclusion Chromatography (SEC) at high temperature (145° C.). A 10 mg syndiotactic polypropylene sample is dissolved at 160° C. in 10 mL of trichlorobenzene (technical grade) for 1 hour. Analytical conditions for the GPC-IR from Polymer Char are:
Injection volume: +/−0.4 mL;
Automatic sample preparation and injector temperature: 160° C.;
Column temperature: 145° C.;
Detector temperature: 160° C.;
Column set: 2 Shodex AT-806MS and 1 Styragel HT6E;
Flow rate: 1 mL/min;
Detector: IRS Infrared detector (2800-3000 cm⁻¹);
Calibration: Narrow standards of polystyrene (commercially available);
Calculation for syndiotactic polypropylene: Based on Mark-Houwink relation (log₁₀(Mpp)=log₁₀(Mps)−0.25323); cut off on the low molecular weight end at M_{PP}=1000;
Calculation for polyethylene: Based on Mark-Houwink relation (log₁₀(M_{PE})=0.965909×log₁₀(M_{PS})−0.28264); cut off on the low molecular weight end at M_{PE}=1000.

The molecular weight averages used in establishing molecular weight/property relationships are the number average (Mₙ), weight average (M_{w}) and z average (M_{z}) molecular weight. These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} \text{/} {M}_{i}} = \frac{{\sum }_{i} {h}_{i}}{{\sum }_{i} {h}_{i} \text{/} {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {M}_{i}} = \frac{{\sum }_{i} {h}_{i} {M}_{i}}{{\sum }_{i} {M}_{i}}$$

$${M}_{i} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{3}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD) is then calculated as Mw/Mn.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well known to the skilled person and include for example sufficient relaxation time etc. In practice the intensity of a signal is obtained from its integral, i.e. the corresponding area. The data is acquired using proton decoupling, 2000 to 4000 scans per spectrum with 10 mm room temperature through or 240 scans per spectrum with a 10 mm cryoprobe, a pulse repetition delay of 11 seconds and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenise the sample, followed by the addition of hexadeuterobenzene (C₆D₆, spectroscopic grade) and a minor amount of hexamethyldisiloxane (HMDS, 99.5+%), with HMDS serving as internal standard. To give an example, about 200 mg to 600 mg of polymer are dissolved in 2.0 mL of TCB, followed by addition of 0.5 mL of C₆D₆ and 2 to 3 drops of HMDS.

Following data acquisition the chemical shifts are referenced to the signal of the internal standard HMDS, which is assigned a value of 2.03 ppm.

The syndiotacticity is determined by ¹³C-NMR analysis on the total polymer in accordance with the method described in U.S. Pat. No. 6,184,326B1 which is incorporated by reference in its entirety.

The comonomer content of a syndiotactic polypropylene or of a polyethylene is determined by ¹³C-NMR analysis of pellets according to the method described by G. J. Ray et al. in Macromolecules, vol. 10, no 4, 1977, p. 773-778.

Percentage of 2,1-insertions for a syndiotactic propylene homopolymer: The signals corresponding to the 2,1-insertions are identified with the aid of published data, for example H. N. Cheng, J. Ewen, Makromol. Chem., vol. 190, 1989, p. 1931-1940. A first area, AREA1, is defined as the average area of the signals corresponding to 2,1-insertions. A second area, AREA2, is defined as the average area of the signals corresponding to 1,2-insertions. The assignment of the signals relating to the 1,2-insertions is well known to the skilled person and need not to be explained further. The percentage of 2,1-insertions is calculated according to:

2,1-insertions (in %)=AREA1/(AREA1+AREA2)×100

with the percentage in 2,1-insertions being given as the molar percentage of 2,1-inserted syndiotactic propylene with respect to total syndiotactic propylene.

Percentage of 2,1-insertions for a random copolymer of syndiotactic propylene and ethylene is determined by two contributions:
A. the percentage of 2,1-insertions as defined above for the syndiotactic propylene homopolymer, and
B. the percentage of 2,1-insertions, wherein the 2,1-inserted syndiotactic propylene neighbors and ethylene,

thus the total percentage of 2,1-insertions corresponds to the sum of these two contributions. The assignments of the signal for case (B) can be done either by using reference spectra or by referring to the published literature.

Melting temperatures Tₘ were determined according to ISO 3146 on a DSC Q2000 instrument by TA Instruments. To erase the thermal history the samples are first heated to 200° C. and kept at 200° C. for a period of 3 minutes. The reported melting temperatures Tₘₑₗₜ are then determined with heating and cooling rates of 20° C./min.

The density is determined according to ISO 1183 at a temperature of 23° C.

Flexural modulus and Notched Izod impact properties are measured on samples of type A1 (ISO 20753) prepared according to standard ISO 1873-2.

Flexural modulus was measured at 23° C. according to ISO 178.

Notched Izod impact strength was measured at 23° C. and −20° C. according to ISO 180.

Falling weight impact properties are measured on type D12 (ISO 20753)−square [(60±2) mm−thickness: (2.0±0.1) mm]−prepared according to standard ISO 1873-2.

Falling weight was measured at 23° C. and −20° C. according to ISO 6603-2 standard. Samples are used with an annular support (40±2) mm diameter. Tests are performed on a Instron (formerly Ceast) Fractovis equipment (reference 7526) with strikers and piezo-electrical load transducer. Data are collected thanks to an interface type DAS 16000 and treated via software.

At least 5 samples are analyzed for each polymer (in agreement with ISO 6603-2 norm).

Scanning Electron Microscope (SEM) analysis was performed. This analysis is described in various documents like “Préparation des échantillons pour MEB et microanalyse”—Philippe Jonnard (GNMEBA)—EDP Sciences or “Polymer Microscopy”—Linda C. Sawyer and David T. Grubb—Ed. Chaoman and Hall.

The used method corresponds to a treatment called “coloration” or “selective labeling”. The objective is an increase of the contrast between various components during observation. This is performed thanks to heavy metal fixation on specific sample phases. In Scanning Electron Microscopy, such method brings a stronger contrast, especially considering retrodiffused electrons. Main used heavy metals are osmium-based (OsO₄) or ruthenium-based (RuO₄). Heavy metal treatment could be performed in liquid phase or in gas phase. For polyethylene, RuO₄ was used. Such treatment amplifies the contrast between amorphous and crystalline phases. RuO₄ treatment is less selective than OsO₄ treatment. A kinetics study is thus required in order to keep a selective labeling (all phases will be labeled after a too long RuO₄ treatment).

To highlight the polyethylene dispersion in syndiotactic polypropylene, observations are performed on a sample cut by cryo-microtone. The prepared surface is then labeled with RuO₄, which will be fixed on polyethylene phase. As soon as labeling is finished, the polyethylene phase will clearly appear when considering retrodiffused electrons and the phase dispersion will be clearly identify.

The following non-limiting examples illustrate the invention.

### Examples

TABLE 1
polymers characterization

| | Unit | mPP1 | mPE1 | mPE2 | PE3 |
|---|---|---|---|---|---|
| MFI | g/10 min | 2.31 | — | — | — |
| (230° C., | | | | | |
| 2.16 kg) | | | | | |
| MFI | g/10 min | — | 2.0 | 3.5 | 2.3 |
| (190° C., | | | | | |
| 2.16 kg) | | | | | |
| Density at | g/cm³ | 0.880 | 0.918 | 0.918 | 0.923 |
| 23° C. | | | | | |
| Notched | kJ/m² | 24.69 | No | n.d. | No |
| Izod | | | break | | break |
| at 23° C. | | | | | |
| Notched | kJ/m² | 2.29 | No | n.d. | 13.96 |
| Izod | | | break | | |
| at −20° C. | | | | | |
| Falling | J | 14.70 | 8.02 | 9.89 | 7.99 |
| weight | | | | | |
| E(break) | | | | | |
| at 23° C. | | | | | |
| Falling | J | n.d. | 12.10 | n.d. | 12.10 |
| weight | | | | | |
| E(break) | | | | | |
| at −20° C. | | | | | |
| Flexural | MPa | 427.6 | 159 | n.d. | 187 |
| modulus | | | | | |
| Melting | ° C. | 125.1 | 110.4 | n.d. | 110.0 |
| tem- | | | | | |
| perature | | | | | |
| Mw | Dalton | 189000 | 69000 | 67300 | 79800 |
| Mw/Mn | — | 4.7 | 2.6 | 2.6 | 5.4 |
| rrrr | % | 78.4 | — | — | — |
| 2, 1 | Mole % | 0.2 | — | — | — |
| insertions | | | | | |

n.d. = not determined

A metallocene syndiotactic polypropylene (mPP1) was blended with three different polyethylenes mPE1, mPE2 and PE3. The metallocene syndiotactic polypropylene used was a bimodal syndiotactic polypropylene commercially available from TOTAL® under the name “Total Finaplas® 1251”. Metallocene catalyst has been used for the production of mPE1 and mPE2, whereas PE3 was produced using high pressure radical production. mPE1 and mPE2 corresponded respectively to the grades M1820 and M1835 commercially available from TOTAL®. PE3 was used to produce comparative blends. PE3 corresponded to the grade LDPE 1022 FN24 commercially available from TOTAL®.

The characteristics of the polymers used in the examples are given in Table 1.

The blends were compounded on the Leistriz ZSE 18HPe twin-screw extruder in following conditions:
screw diameter: 18 mm
screw length/diameter ratio=40
imposed temperature profile along the screw (in ° C.): 200-210-215-220-220-215-210-210 (this last temperature is the one imposed at the die)
screw speed: 250 rpm
feeding rate: 2.0 kg/h

In such conditions, measured torque is regularly of the order of 40 Nm.

For mechanical properties evaluations, the blends were injected on the DR BOY 22A press in both tensile bars and 1 mm-squares samples. The blends rheological measurements were performed at 230° C. Table 2 presents the specificity of the blend compositions.

TABLE 2
blends composition

| | | | | PE3 | |
|---|---|---|---|---|---|
| | mPP1 | mPE1 | mPE2 | (comp) | |
| | wt % | wt % | wt % | wt % | α |
| B1 | 25 | 75 | — | — | 0.53 |
| B2 | 45 | 55 | — | — | 0.96 |
| B3 | 50 | 50 | — | — | 1.08 |
| B4 | 55 | 45 | — | — | 1.18 |
| B5 | 65 | 35 | — | — | 1.40 |
| B6 | 75 | 25 | — | — | 1.61 |
| B7 | 50 | — | 50 | — | 0.83 |
| B8 | 55 | — | 45 | — | 0.91 |
| B9 | 10 | — | — | 90 | 0.20 |
| B10 | 25 | — | — | 75 | 0.50 |
| B11 | 45 | — | — | 55 | 0.90 |
| B12 | 55 | — | — | 45 | 1.10 |
| B13 | 65 | — | — | 35 | 1.30 |

The blend B6 was prepared with a metallocene polyethylene but not in the inventive blend proportions, thus B6 is a comparative example of the invention.

The properties obtained on the resulting blends are presented in tables 3 and 4.

TABLE 3
blends properties

| | | MFI | | Flexural |
|---|---|---|---|---|
| | | 230° C./2.16 kg | Tm | Modulus |
| | α | g/10 min | ° C. | MPa |
| B1 | 0.53 | 3.24 | 109.7 | 214 |
| B2 | 0.96 | 3.04 | 110.1 | 278 |
| B4 | 1.18 | 2.92 | 109.7 | 314 |
| B5 | 1.40 | 2.75 | 109.2 | 342 |
| B6 | 1.61 | 2.68 | 108.8 | 381 |
| B7 | 0.83 | 4.82 | 107.2 | 274 |
| B8 | 0.91 | 4.55 | 107.6 | 289 |
| B10 | 0.50 | 5.07 | 110.4 | 242 |
| B11 | 0.90 | 4.71 | 110.5 | 296 |
| B12 | 1.10 | 3.60 | 110.1 | 321 |
| B13 | 1.30 | 3.52 | 109.7 | 352 |

From the results of table 3, it can be seen that the melting temperature and the flexural modulus were kept at the same level between the inventive and comparative blends. The differences observed result from the starting polyethylene material.

TABLE 4
impact properties

| | | | Falling | Falling | |
|---|---|---|---|---|---|
| | | | weight | weight | |
| | | Izod | E(break) | E(break) | Ductility |
| | | at −20° C. | at 23° C. | at −20° C. | index |
| | α | kJ/m² | J | J | % |
| B1 | 0.53 | 11.13 | n.d. | 16.11 | 42.6 |
| B2 | 0.96 | 4.05 | 9.58 | 15.10 | 42.5 |
| B4 | 1.18 | 3.73 | 9.84 | 15.23 | 42.2 |
| B5 | 1.40 | 2.75 | 9.88 | 7.38 | 4.8 |
| B6 | 1.61 | 2.91 | 10.38 | 0.12 | 8.3 |
| B7 | 0.83 | 3.48 | 9.68 | 16.07 | 44.9 |
| B8 | 0.91 | 3.18 | 10.00 | 16.94 | 43.8 |
| B10 | 0.50 | 3.16 | 9.80 | 14.78 | 34.9 |
| B11 | 0.90 | 2.62 | 10.24 | 12.16 | 31.0 |
| B12 | 1.10 | 2.38 | 10.51 | 7.00 | 21.1 |
| B13 | 1.30 | 2.55 | 10.64 | 0.10 | n.d. |

n.d. = not determined

For all blends no break was observed regarding notched Izod at 23° C.

Surprising results were observed regarding the falling weight impact properties at −20° C. Indeed, whereas the starting material mPE1 and PE3 showed similar values, blends comprising mPE1 or PE3 had a different behavior. For the blends with a being below 1.60, preferably with a being at most 1.40, the energy at break was higher for the blends comprising mPE compared to the others.

The failure mechanism showed also differences. Ductile breaks were systematically observed in blends comprising mPE1 or mPE2 and a being lower or equal to 1.40. Whereas a mixture of ductile and fragile breaks was observed in blends comprising PE3 and a being lower or equal to 1.30. The lower the a was, the more ductile break proportion was observed but even with a as low as 0.20, one fragile break was observed (for 5 tests) on PE3/mPP blends. The ductile/fragile tests results are given in below table 5. At the same time the ductility index was calculated from the results of the falling weight impact properties

The ductility index is determined at −20° C. and according to the following equation:

$$Ductility index ( \% ) = \frac{E ( break ) - E ( peak )}{E ( break )} \times 100 \qquad ( II )$$

wherein E(break) is the falling weight average energy at break (in Joule) as determined at −20° C. and E(peak) is the falling weight average energy at peak (in Joule) as determined at −20° C.

By default, a ductility index lower or equal to 10 is associated to “fragile break”; a value ranging between 10 and 35 correspond to an intermediate break; above 35, the break is ductile. From the results of tables 4 and 5, it could be seen that the ductility index increases when decreasing a:
Considering, samples B1, B2 and B4, falling weight at −20 C are associated to a values of, respectively, 0.53, 0.96 and 1.18. So even at α=1.18, the break is ductile;
However, for the comparative examples B10, B11 and B12, the ductility index is below 35 (or just close to 35 in the case of sample B10). By defect, such value is associated to intermediate breaks between ductile and fragile.

Therefore, purely ductile breaks are observed in a broader range of ductility index when blending two metallocene grades.

For low α values (below 0.50), a ductility index higher than 35, so associated to purely ductile break, could be obtained in blends with most polyethylene grades, not solely with a blend containing metallocene polyethylene grades.

TABLE 5
Ductility properties

| | | | Ductility index |
|---|---|---|---|
| | α | ductile/fragile | % |
| B1 | 0.53 | 5/0/0 | 42.6 |
| B2 | 0.96 | 5/0/0 | 42.5 |
| B4 | 1.18 | 5/0/0 | 42.2 |
| B5 | 1.40 | 0/0/5 | 4.8 |
| B7 | 0.83 | 5/0/0 | 44.9 |
| B8 | 0.91 | 5/0/0 | 43.8 |
| B9 | 0.20 | 4/0/1 | 32.4 |
| B10 | 0.50 | 5/0/0 | 34.9 |
| B11 | 0.90 | 2/2/1 | 31.0 |
| B12 | 1.10 | 0/2/3 | 21.1 |
| B13 | 1.30 | 0/0/5 | n.d. |

n.d. = not determined

From the results of table 5 it can be seen that the inventive polyolefins blends showed improvement with regard to ductility at −20° C.

Morphology of the Blends

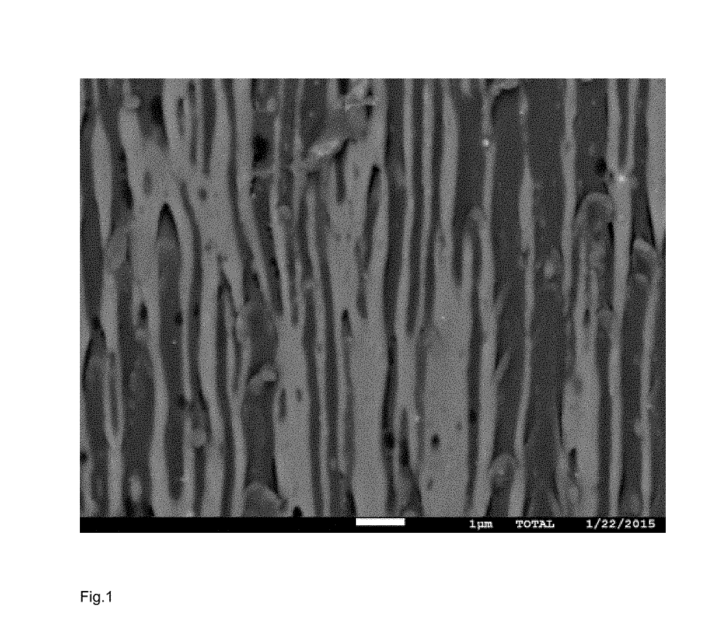

Blends of mPP1 with mPE1, mPE2 and PE3 were produced with a being close to 1. In the three blends the presence of co-continuous phase was determined by SEM. FIG. 1 is a picture of the co-continuous morphology for the blend B3 with a equal to 1.08.

The inventive polyolefin blends are therefore characterized by an improved balance of rigidity, processability and impact properties, including ductility and impact resistance below 0° C.

1.-15. (canceled)

16. A blend of at least one single-site catalyst polyethylene and at least one single-site catalyst syndiotactic polypropylene with a syndiotactic polypropylene content φ_{PP} in weight percent relative to the total weight of both the polyethylene and the syndiotactic polypropylene contained in the blend corresponding to:
$${ϕ}_{PP} = α \frac{100 MI {2}_{PE}}{{MFI}_{PP} + MI {2}_{PE}}$$
with α being at most 1.40, MI2_{PE} being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg, wherein the content of syndiotactic polypropylene is at most 60 w % relative to the total weight of both the polyethylene and the syndiotactic polypropylene contained in the blend.

17. The blend according to claim 16, wherein a is:
at most 1.30, and/or
at least 0.50.

18. The blend according to claim 16, wherein the content of syndiotactic polypropylene is at most 55 wt %, relative to the total weight of both the polyethylene and the syndiotactic polypropylene contained in the blend.

19. The blend according to claim 16, wherein the content of the syndiotactic polypropylene is at least 25 wt %, relative to the total weight of both polyethylene and syndiotactic polypropylene contained in the blend.

20. The blend according to claim 16, wherein both the polyethylene and the syndiotactic polypropylene have a molecular weight distribution Mw/Mn of at most 5 and/or of at least 2.1.

21. The blend according to claim 16, wherein the polyethylene has a MI2 of at least 1.5 g/10 min as measured according to ISO 1133 at 190° C. under a load of 2.16 kg.

22. The blend according to claim 16, wherein at least one single-site catalyst catalyzed polyethylene is a metallocene polyethylene and/or at least one single-site catalyst catalyzed syndiotactic polypropylene is a metallocene syndiotactic polypropylene.

23. The blend according to claim 16, wherein the blend further comprises from 0.1 wt % to 50 wt % of a filler, and the filler comprises one or more reinforcement material selected from glass fibers and carbon nanotubes.

24. The blend according to claim 16, wherein the syndiotactic polypropylene and the polyethylene are in co-continuous phases.

25. The blend according to claim 16, wherein the blend has a ductility index determined at −20° C. of at least 35%, preferably at least 40%, the ductility index being calculated to the following equation (II):
$$Ductility index ( \% ) = \frac{E ( break ) - E ( peak )}{E ( break )} \times 100 \qquad ( II )$$
wherein E(break) is the falling weight average energy at break as determined at −20° C. and E(peak) is the falling weight average energy at peak as determined at −20° C.

26. The blend according to claim 22 characterized in that the at least one single-site catalyst catalyzed syndiotactic polypropylene in the blend is a syndiotactic polypropylene-based composition comprising at least one single-site catalyst catalyzed syndiotactic polypropylene and from 0.1 to 30 wt % of an isotactic polypropylene as based on the total weight of the syndiotactic polypropylene-based composition.

27. An article produced from the blend according to claim 16, wherein
the article is a thermoformed article or a molded article selected from injection molded article, compression molded article, rotomoulded article, injection blow molded article, and injection stretch blow molded article, and/or
the article is selected from the group consisting of automobile parts, food or non-food packaging, retort packaging, housewares, caps, closures, media packaging, medical devices and pharmacopoeia packages.

28. A process for the production of a blend comprising the steps of:
providing at least one syndiotactic polypropylene produced in the presence of a single-site catalyst in one or more reactors;
providing at least one polyethylene produced in the presence of a single-site catalyst in one or more reactors;
blending said at least one syndiotactic polypropylene together with said at least one polyethylene to produce a blend wherein the syndiotactic polypropylene content co in weight percent relative to the total weight of both polyethylene and syndiotactic polypropylene contained in the blend is:
$${ϕ}_{PP} = α \frac{100 MI {2}_{PE}}{{MFI}_{PP} + MI {2}_{PE}}$$
with α being at most 1.40, MI2PE being the melt flow index of the polyethylene as measured according to ISO 1133 at 190° C. under a load of 2.16 kg and MFI_{PP} being the melt flow index of the syndiotactic polypropylene as measured according to ISO 1133 at 230° C. under a load of 2.16 kg, wherein the content of syndiotactic polypropylene is at most 60 w % relative to the total weight of both the polyethylene and the syndiotactic polypropylene contained in the blend.

29. The process according to claim 28 wherein:
the at least one syndiotactic polypropylene and/or the at least one polyethylene are produced in a loop reactor, and/or
the blending of the at least one syndiotactic polypropylene together with the at least one polyethylene to produce a blend is a physical blending, and/or
the process has no step of blending a compatiliser selected from polypropylene grafted with maleic anhydride, polyethylene grafted with maleic anhydride, ethylene-vinyl acetate grafted with maleic anhydride, ethylene-octene copolymer (POE), ethylene-propylene rubber (EPR), ethylene-propylene diene rubber (EPDM) styrene-ethylene/butylene-styrene (SEBS) or any mixture thereof, together with the at least one syndiotactic polypropylene and/or the at least one polyethylene.
